(19) United States
(12) Patent Application Publication
(10) Pub. No.: US 2025/0293838 A1
(43) Pub. Date: Sep. 18, 2025

(54) ELECTRONIC DEVICE IN WIRELESS COMMUNICATION SYSTEM AND OPERATING METHOD THEREOF

(71) Applicant: SAMSUNG ELECTRONICS CO., LTD., Suwon-si (KR)

(72) Inventors: Jinwoo OH, Suwon-si (KR); Jungmin Park, Suwon-si (KR); Hongsik Yoon, Suwon-si (KR); Junho Lee, Suwon-si (KR)

(73) Assignee: SAMSUNG ELECTRONICS CO., LTD., Suwon-si (KR)

(21) Appl. No.: 19/076,248

(22) Filed: Mar. 11, 2025

(30) Foreign Application Priority Data
Mar. 12, 2024 (KR) 10-2024-0034724
Jul. 26, 2024 (KR) 10-2024-0099708

(51) Int. Cl. H04L 5/00; H04B 17/336; H04W 72/232

(52) U.S. Cl. CPC H04L 5/0051; H04B 17/336; H04L 5/0016; H04W 72/232

(57) ABSTRACT

An operating method of an electronic device, including: receiving a signal comprising a Demodulation Reference Signal (DMRS) and Physical Downlink Shared Channel (PDSCH) data; determining whether a co-scheduled neighboring electronic device is present, based on despread of the DMRS; performing channel estimation on each of a serving channel for the electronic device and an interference channel for a neighboring electronic device, based on the despread of the DMRS; calculating a variance of noise not including an interference signal, based on the co-scheduled neighboring electronic device; calculating a Signal-to-Noise-Ratio (SNR) for the DMRS and a Signal-to-Interference-Noise-Ratio (SINR) for the PDSCH data; and decoding the PDSCH data based on the SINR.

### CROSS-REFERENCE TO RELATED APPLICATIONS

This application is based on and claims priority under 35 U.S.C. § 119 to Korean Patent Application Nos. 10-2024-0034724, filed on Mar. 12, 2024, and 10-0099708, filed on Jul. 26, 2024, in the Korean Intellectual Property Office, the disclosures of which are incorporated by reference herein in their entireties.

### BACKGROUND

The disclosure relates to a wireless communication system, and more particularly, to an electronic device for performing channel estimation in the wireless communication system and an operating method of the electronic device.

New Radio (NR) Release 18 proposed a Multi-User Multiple Input Multiple Output (MU-MIMO) scenario that provides an indication to an electronic device of presence of a co-scheduled User Equipment (UE). The UE may be aware of the MU-MIMO scenario and improve the performance of the UE and the overall throughput of the entire network through joint detection.

However, in the previous 3rd Generation Partnership Project (3GPP) standards, the MU-MIMO scenario is transparent to the UE, and thus, the UE may not be aware of the presence of a co-scheduled UE in the same Code Division Multiplexing (CDM) group as the UE itself. A UE expects interference control from a base station, but there may be cases where the control is not easy due to, for example, an antenna array structure of the base station. In such situation, the UE may experience performance loss in channel estimation, Signal-to-Interference-Noise-Ratio (SINR) estimation, and interference control.

### SUMMARY

Provided are an electronic device for performing channel estimation based on detection of the presence or absence of a co-scheduled neighboring electronic device and an operating method of the electronic device.

According to an aspect of the disclosure, an operating method of an electronic device, including: receiving a signal comprising a Demodulation Reference Signal (DMRS) and Physical Downlink Shared Channel (PDSCH) data; determining whether a co-scheduled neighboring electronic device is present, based on despread of the DMRS; performing channel estimation on each of a serving channel for the electronic device and an interference channel for a neighboring electronic device, based on the despread of the DMRS; calculating a variance of noise not including an interference signal, based on the co-scheduled neighboring electronic device; calculating a Signal-to-Noise-Ratio (SNR) for the DMRS and a Signal-to-Interference-Noise-Ratio (SINR) for the PDSCH data; and decoding the PDSCH data based on the SINR.

According to an aspect of the disclosure, an electronic device includes: a wireless communication circuit configured to receive a signal comprising a Demodulation Reference Signal (DMRS) and Physical Downlink Shared Channel (PDSCH) data; and a processor operatively connected to the wireless communication circuit, wherein the processor is configured to: determine whether a co-scheduled neighboring electronic device is present, based on despread of the DMRS, perform channel estimation on each of a serving channel for the electronic device and an interference channel for the co-scheduled neighboring electronic device, based on the despread of the DMRS, calculate a variance of noise not including an interference signal, based on the co-scheduled neighboring electronic device, calculate a Signal-to-Noise-Ratio (SNR) for the DMRS and a Signal-to-Interference-Noise-Ratio (SINR) for the PDSCH data, and decode the PDSCH data based on the SINR.

According to an aspect of the disclosure, a wireless communication system includes: a base station configured to transmit a signal comprising a Demodulation Reference Signal (DMRS) and Physical Downlink Shared Channel (PDSCH) data multiplexed based on an Orthogonal Cover Code (OCC); and an electronic device configured to: determine whether a co-scheduled neighboring electronic device is present, based on despread of the DMRS, perform channel estimation on each of a serving channel for the electronic device and an interference channel for the co-scheduled neighboring electronic device, based on the despread of the DMRS, calculate a variance of noise not including an interference signal, based on the co-scheduled neighboring electronic device, calculate a Signal-to-Noise-Ratio (SNR) for the DMRS and a Signal-to-Interference-Noise-Ratio (SINR) for the PDSCH data, and decode the PDSCH data based on the SINR.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a wireless communication system according to an embodiment;

FIG. 2A illustrates an example of New Radio (NR) Physical Downlink Shared Channel (PDSCH) Demodulation Reference Signal (DMRS) configuration type 1 and FIG. 2B illustrates an example of NR PDSCH DMRS configuration type 2;

FIG. 3 illustrates an electronic device according to an embodiment;

FIG. 4 illustrates an operation method of an electronic device, according to an embodiment;

FIG. 5 illustrates details of an operation of an electronic device, according to an embodiment;

FIG. 6 illustrates details of an operation of an electronic device, according to an embodiment;

FIG. 7 illustrates a Multiple Input Multiple Output (MIMO) environment according to an embodiment; and

FIG. 8 illustrates a wireless communication device according to an embodiment.

### DETAILED DESCRIPTION OF THE EMBODIMENTS

Hereinafter, embodiments will be described in detail with reference to the accompanying drawings.

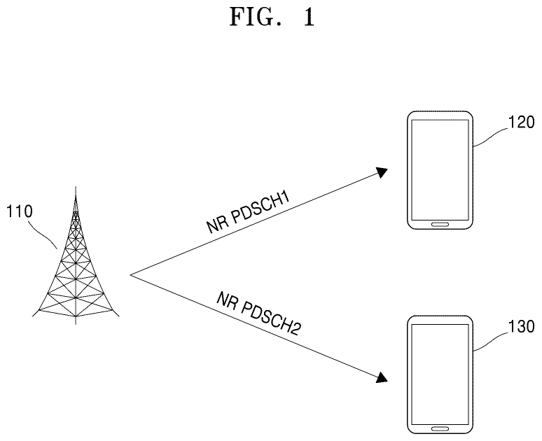

FIG. 1 illustrates a wireless communication system according to an embodiment. In FIG. 1, the wireless communication system may include a base station 110, an electronic device 120, and a neighboring electronic device 130. The base station 110 may be used interchangeably with an Access Point (AP), an Evolved NodeB (eNB), a 5th Generation (5G) node, a wireless point, or other terms having equivalent technical meanings. The electronic device 120 may be used interchangeably with a terminal, a user equipment (UE), a mobile station, a subscriber station, a customer premises equipment (CPE), a remote terminal, a wireless terminal, a user device, or other terms having equivalent technical meanings.

According to one or more embodiments, the base station 110 is a network infrastructure that provides radio access to the electronic device 120 and the neighboring electronic device 130. The base station 110 may have a coverage defined as a certain geographic area based on a signal transmittable distance.

According to one or more embodiments, the base station 110 may be connected to one or more Transmission/Reception Points (TRPs). The base station 110 may transmit a downlink signal to the electronic device 120 or receive an uplink signal through the one or more TRPs. According to an embodiment, the base station 110 may transmit a physical channel to the electronic device 120. For example, the physical channel may include a Physical Downlink Shared Channel (PDSCH). The physical channel may further include a Reference Signal (RS). For example, the PDSCH may include a new radio (NR) PDSCH Demodulation Reference Signal (DMRS).

The electronic device 120 may perform channel estimation on the physical channel. The channel estimation may be based on a Linear Minimum Mean Square Error (LMMSE). The electronic device 120 may perform channel estimation on N_{RE} Resource Elements (REs) included in one or more Resource Blocks (RBs) by using N_{RS} NR PDSCH DMRS resources.

According to one or more embodiments, the electronic device 120 and the neighboring electronic device 130 are used by users and may communicate with the base station 110 over a radio channel. For example, the electronic device 120 may receive NR PDSCH1 from the base station 110 and the neighboring electronic device 130 may receive NR PDSCH2 from the base station 110. At this time, NR PDSCH1 and NR PDSCH2 may be the same signal transmitted from the base station 110. For example, in a Multi-User Multiple Input Multiple Output (MU-MIMO) environment, the base station 110 may multiplex the DMRS of NR PDSCH1 and the DMRS of NR PDSCH2 with orthogonal codes on the same resource and transmit the multiplexed signals. On the other hand, the RE of NR PDSCH1 (e.g., PDSCH data channel) and the RE of NR PDSCH2 may be transmitted without multiplexing based on orthogonal codes.

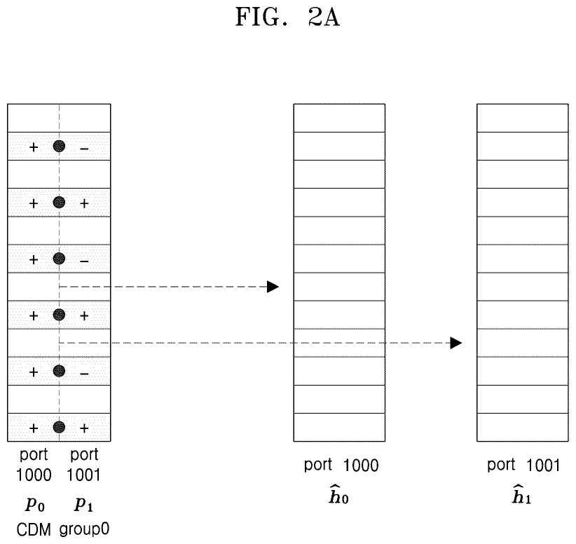

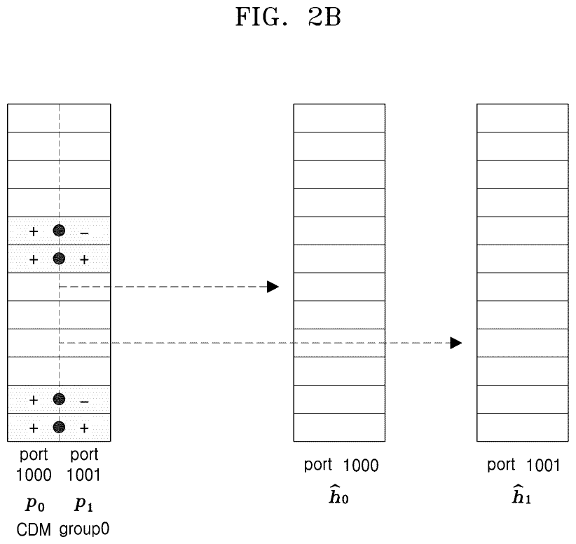

FIG. 2A illustrates an example of NR PDSCH DMRS configuration type 1. FIG. 2B illustrates an example of NR PDSCH DMRS configuration type 2.

In FIGS. 2A and 2B, a physical channel may include RSs. The RSs may be arranged at each RE of predefined intervals along a frequency domain. For example, the RS may include at least a DMRS of an NR PDSCH.

In FIGS. 2A and 2B, the structure of the NR PDSCH DMRS in 1RB and 1 symbol is illustrated. For NR PDSCH DMRS configuration type 1, RSs may be arranged at intervals of 2 REs. For example, RSs may be arranged in each odd RE. For NR PDSCH DMRS configuration type 2, RSs may be arranged at intervals of 6 REs and neighboring RSs may be arranged neighboring in RE units in the frequency domain. For example, RSs may be arranged in the first, second, seventh, and eighth REs. Since different Code Division Multiplexing (CDM) groups are orthogonal in the frequency domain, only CDM group 0 is considered in FIG. 2A and this may be applied similarly to other CDM groups. DMRS signals of ports 1000 and 1001 may be mixed and input to CDM group 0. The ports may be distinguished by an orthogonal cover code (OCC) of [++] or [+−]. The channel of the port 1000 may correspond to a serving channel and the channel of the port 1001 may correspond to an interference channel. The DMRS received by the electronic device 120 may be represented by the following equation (Equation 1).

$$y [ 2 k ] = ( {h}_{0} [ 2 k ] + {( - 1 )}^{k} {h}_{1} [ 2 k ] ) x [ 2 k ] + n [ 2 k ] \qquad [ Equation 1 ]$$

In Equation 1 above, 2k is the location of the DMRS in the frequency domain, h₀[2k] is the channel of the port 1000 (or the serving channel), h₁[2k] is the channel of the port 1001 (or the interference channel) for the co-scheduled neighboring electronic device 130, n[2k] is a noise component, and a (−1)^{k} component is a component multiplied by the interference channel according to an OCC.

According to one or more embodiments, the electronic device 120 and the neighboring electronic device 130 may be based on the same DMRS sequence. For example, the base station 110 may provide the same DMRS sequence to the electronic device 120 and the neighboring electronic device 130 through an Radio Resource Control (RRC) signaling.

As another example, when the base station 110 does not perform the RRC signaling, the DMRS sequence may be based on a cell identification (ID). Since the serving cell of the electronic device 120 and the serving cell of the neighboring electronic device 130 are the same as the base station 110, the DMRS sequence of the electronic device 120 may be identical to the DMRS sequence of the neighboring electronic device 130. In Equation 1 above, since the DMRS sequences are identical to each other and have x[2k] in common, the serving channel and the interference channel appear to be merged.

The electronic device 120 may perform channel estimation on N_{RE} channels by using N_{RS} NR PDSCH DMRSs. For example, when channel estimation in the frequency domain is performed in units of 1 symbol and 1 RB in NR PDSCH DMRS configuration type 1, N_{RS}=6 and N_{RE}=12, and when channel estimation in the frequency domain is performed in units of 1 symbol and 2 RBs in NR PDSCH DMRS configuration type 2, N_{RS}=8 and N_{RE}=24.

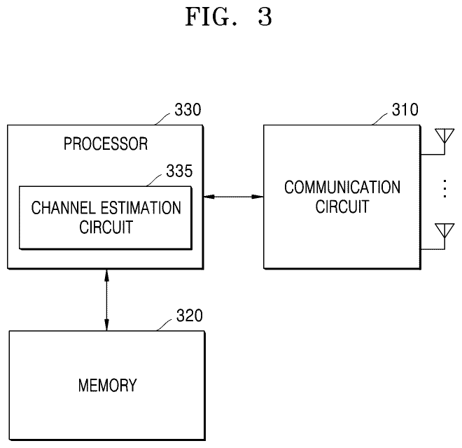

FIG. 3 illustrates an electronic device 300 according to an embodiment. In FIG. 3, the electronic device 300 may include a processor 330, a communication circuit 310, and a memory 320. The electronic device 300 of FIG. 3 may correspond to the electronic device 120 of FIG. 1.

According to an embodiment, the communication circuit 310 may perform functions for transmitting and receiving signals over a radio channel. For example, the communication circuit 310 may perform a conversion function between a baseband signal and a bit stream in accordance with a physical layer protocol of a system. For example, upon data transmission, the communication circuit 310 may generate complex symbols by encoding and modulating a transmission bit stream, and upon data reception, the communication circuit 310 may restore a reception bit stream by demodulating and decoding a baseband signal. Furthermore, the communication circuit 310 may up-convert a baseband signal into a radio frequency (RF) band signal and transmit the RF band signal through an antenna, or may down-convert the RF band signal received through the antenna into a baseband signal. For example, the communication circuit 310 may include a transmission filter, a reception filter, an amplifier, a mixer, an oscillator, a Digital-to-Analog Converter (DAC), an Analog-to-Digital Converter (ADC), and the like. The communication circuit 310 may perform beamforming. The communication circuit 310 may apply beamforming weights to the signals so as to impart directionality to the signals to be transmitted and received.

The communication circuit 310 may transmit and receive signals. The communication circuit 310 may receive a downlink signal or transmit an uplink signal. The downlink signal may include a Synchronization Signal (SS), an RS, system information, a configuration message, control information, or downlink data. The communication circuit 310 may receive, from the base station 110, a downlink physical channel (e.g., NR PDSCH) including the RS. For example, the communication circuit 310 may receive an NR PDSCH including a DMRS.

According to an embodiment, the memory 320 may store data such as configuration information, application programs, and basic programs for the operation of the electronic device 120. The memory 320 may include a volatile memory, a non-volatile memory, or a combination of a volatile memory and a non-volatile memory. For example, the memory 320 may store a threshold value. The threshold value may be a value that serves as a criterion for determining the presence or absence of a co-scheduled UE. The electronic device 120 may determine the presence or absence of a device (e.g., the neighboring electronic device 130) co-scheduled with the electronic device 120 by comparing a channel power value of a second port (e.g., the port 1001) with the threshold value.

According to an embodiment, the processor 330 may control the overall operation of the electronic device 300. For example, the processor 330 may control the communication circuit 310 to transmit and receive signals. In addition, the processor 330 may write data to the memory 320 and read data from the memory 320. For example, the processor 330 may read the threshold value from the memory 320 for comparison with the calculated channel power value of the second port. To this end, the processor 330 may include at least one processor or microprocessor, or may be a portion of a processor. When the processor 330 is a portion of a processor, a portion of the communication circuit 310 and the processor 330 may be referred to as a communication processor (CP).

According to an embodiment, the processor 330 may further include a channel estimation circuit 335. The channel estimation circuit 335 may perform LMMSE-based channel estimation on the received signal. However, the method of performing channel estimation thereon is not limited to the LMMSE. According to one or more embodiments, the channel estimation circuit 335 may perform channel estimation in any scheme using a Signal-to-Interference-Noise-Ratio (SINR).

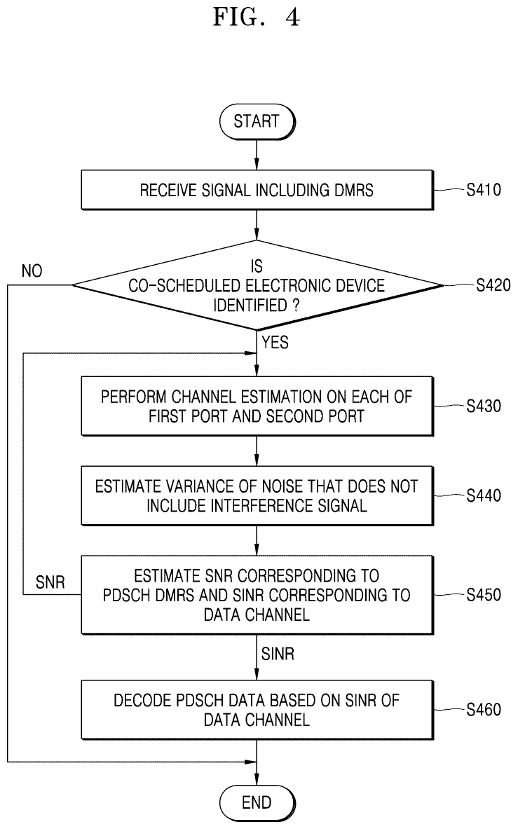

FIG. 4 illustrates an operation method of the electronic device 120, according to an embodiment. In FIG. 4, in operation S410, the electronic device 120 may receive a signal including a DMRS. The received signal may correspond to an NR PDSCH. The processor 330 may control the communication circuit 310 to receive the NR PDSCH including the DMRS. In this case, the PDSCH may include six (6) RSs in one symbol and one RB according to NR PDSCH DMRS configuration type 1, or may include four (4) RSs in one symbol and one RB according to NR PDSCH DMRS configuration type 2. The serving channel of the first port and the interference channel of the second port may be multiplexed based on the OCC and transmitted through the NR PDSCH DMRS.

In operation S420, the electronic device 120 may determine whether the co-scheduled electronic device (e.g., the neighboring electronic device 130 of FIG. 1) is identified. The electronic device 120 may separate the first port from the second port by using the multiplexing of the received signal based on the OCC. For example, the electronic device 120 may obtain a despread serving channel by summing neighboring DMRSs and dividing the sum by 2 to separate the first port, as shown in the below equation (Equation 2).

$${\tilde{h}}_{0} ≅ \frac{{x}^{*} [ 2 k ] y [ 2 k ] + {x}^{*} [ 2 k + 2 ] y [ 2 k + 2 ]}{2} ≅ {h}_{0} + \frac{n [ 2 k ] + n [ 2 k + 2 ]}{2} \qquad [ Equation 2 ]$$

\tilde{h}₀ represents the despread serving channel and h₀ represents the effective serving channel. In Equation 2, it may be confirmed that the despread serving channel \tilde{h}₀ does not include any term related to the interference channel. The SINR of the serving channel is calculated as follows (Equation 3).

$${SINR}_{DMRS}^{PDSCH} = \frac{2 {P}_{0}}{{σ}^{2}} \qquad [ Equation 3 ]$$

P₀ is the channel power value of the serving channel and is P₀=E{h₀*h₀} and σ² is the power value of noise and is σ²=E{n*n}. However, the noise variance of the DMRS calculated based on the conventional LMMSE-based channel estimation is as follows (Equation 4).

$${\hat{σ}}^{2} = E [ {\vert y [ 2 k ] - {\sum }_{t = 0}^{{N}_{port} - 1} {\hat{h}}_{t} [ 2 k ] {( - 1 )}^{k} x [ 2 k ] \vert}^{2} ] \qquad [ Equation 4 ]$$

Nₚₒᵣₜ is the number of DMRS ports allocated to the corresponding CDM group and may be delivered to the electronic device 120 through RRC signaling or downlink control indicator (DCI). As in the related art, Nₚₒᵣₜ=1 and this may be as follows (Equation 5) on the assumption that channel estimation is perfect.

$${\hat{σ}}^{2} = E [ \vert {\hat{h}}_{1} [ 2 k ] {( - 1 )}^{k} + n [ 2 k ] {\vert}^{2} ] = {P}_{1} + {σ}^{2} \qquad [ Equation 5 ]$$

P₁ is P₁=E{h₁*h₁}, which is the channel power value of the interference channel the channel of the co-scheduled neighboring electronic device 130. That is, in the case of the DMRS, the performance, including the P₁ term, may degrade even though the signal of the neighboring electronic device 130 that is OCCed and co-scheduled is not received due to interference.

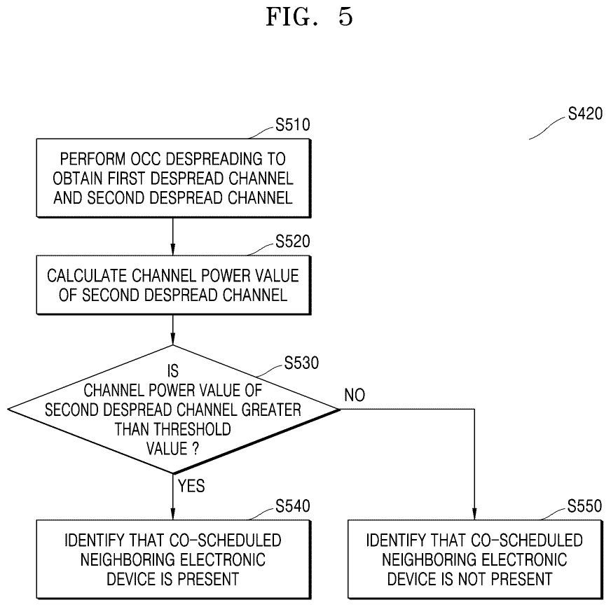

The electronic device 120 may obtain the channel power value for the despread interference channel of the second port and may determine the presence or absence of the neighboring electronic device 130 corresponding to the second port, based on the channel power value. Details of operation S420 are described below with reference to FIG. 5.

In operation S430, the electronic device 120 may perform channel estimation for each of the first port and the second port. Since it is determined in operation S420 that the co-scheduled neighboring electronic device 130 is present, the electronic device 120 may identify the presence of the serving channel corresponding to the first port and the interference channel corresponding to the second port.

Since the DMRS sequence of the electronic device 120 is identical to the DMRS sequence of the neighboring electronic device 130, the electronic device 120 may simultaneously perform channel estimation on each of the serving channel of the first port and the interference channel of the second port. The electronic device 120 may perform channel estimation on the serving channel and the interference channel according to the following equations (Equation 6 and Equation 7).

$$\begin{matrix}{\tilde{h}}_{0} = {W}_{0} {\tilde{h}}_{0} & [ Equation 6 ] \\ {\tilde{h}}_{1} = {W}_{1} {\tilde{h}}_{1} & [ Equation 7 ]\end{matrix}$$

W₀ and W₁ are each an LMMSE-based weight matrix for channel estimation. In this case, the SINR used in the weight matrix may use an SNR that does not include interference. At this time, the SNR used to calculate the weight matrix may be an SNR estimated in a previous slot. For example, when channel estimation is performed on each of the first port and the second port corresponding to an n^{th} slot, the SNR used in the weight matrix may be an SNR estimated in an (n−1)^{th} slot. That is, the SNR obtained according to operation S450 of the (n−1)^{th} slot may be used for channel estimation on the first port and the second port in operation S430 of the n^{th} slot.

$${SINR}_{DMRS}^{PDSCH} = \{ \begin{matrix}\frac{2 {P}_{0}}{{σ}^{2}} for {W}_{0} \\ \frac{2 {P}_{1}}{{σ}^{2}} for {W}_{1}\end{matrix} \qquad [ Equation 8 ]$$

P₀ is the channel power value of the serving channel and is P₀=E{h₀*h₀} and σ² is the power value of noise and is σ²=E{n*n}. P₁ is the channel power value of the interference channel and is P₁=E{h₁*h₁}.

In operation S440, the variance of noise that does not include the interference signal may be estimated. Since the PDSCH DMRS and PDSCH data channels each experience an SNR and an SINR, the noise and the interference channel components of the co-scheduled neighboring electronic device 130 has to be calculated separately. The noise variance that does not include the interference signal may be calculated according to the following equation (Equation 9).

$${\hat{σ}}^{2} = E [ {\vert y [ 2 k ] - {\sum }_{t = 0}^{{N}_{port} - 1} {\hat{h}}_{t} [ 2 k ] {( - 1 )}^{k} x [ 2 k ] \vert}^{2} ] = {σ}^{2} \qquad [ Equation 9 ]$$

The electronic device 120 may receive the value of Nₚₒᵣₜ=1 through RRC signaling and/or DCI. However, when the neighboring electronic device 130 is detected in operation S420, Nₚₒᵣₜ=2.

In operation S450, the electronic device 120 may estimate an SNR corresponding to the PDSCH DMRS and an SINR corresponding to the data channel. For example, the electronic device 120 may calculate Equation 3 as the SNR corresponding to the PDSCH DMRS by using the noise variance calculated in operation S440. The calculated SNR may be used for channel estimation of the next slot. For example, the SNR calculated in operation S450 of the n^{th} slot may be provided to operation S430 of the (n+1)^{th} slot and used to calculate the weight matrix for channel estimation of the next slot.

In addition, the electronic device 120 may calculate the SINR corresponding to the PDSCH data channel according to the following equation.

$${SINR}_{Data}^{PDSCH} = \frac{{P}_{0}}{{P}_{1} + {σ}^{2}} \qquad [ Equation 10 ]$$

In operation S460, the electronic device 120 may decode the PDSCH data based on the SINR of the data channel. The electronic device 120 may perform operations related to decoding of the PDSCH data, based on the SINR including the interference component. For example, the electronic device 120 may calculate a Log-Likelihood Ratio (LLR) based on the SINR of Equation 10 above.

FIG. 5 illustrates details of operation S420 of the electronic device 120, according to an embodiment.

In FIG. 5, in operation S510, the electronic device 120 may perform OCC despreading to obtain a first despead channel, and a second despread channel. For example, the electronic device 120 may obtain a despread interference channel by subtracting between neighboring DMRSs and dividing a result of the subtracting by 2 to separate the second port, as shown below.

$${\tilde{h}}_{1} ≅ \frac{{x}^{*} [ 2 k ] y [ 2 k ] - {x}^{*} [ 2 k + 2 ] y [ 2 k + 2 ]}{2} ≅ {h}_{1} + \frac{n [ 2 k ] - n [ 2 k + 2 ]}{2} \qquad [ Equation 11 ]$$

\tilde{h}₁ represents the despread interference channel and h₁ represents the effective interference channel.

In operation S520, the electronic device 120 may calculate the channel power value of the second despread channel. For example, the electronic device 120 may calculate the channel power value of the second despread channel according to the following equation (Equation 12).

$${P}_{1} = E [ {\vert {\tilde{h}}_{1} \vert}^{2} ] or \\ {P}_{1} = E [ \vert {\tilde{h}}_{1}^{*} [ 2 k + 2 ] {\tilde{h}}_{1} [ 2 k ] \vert ] \qquad [ Equation 12 ]$$

In operation S530, the electronic device 120 may compare whether the channel power value of the second despread channel is greater than a threshold value. For example, the electronic device 120 may determine whether P₁>γ is satisfied. γ is a threshold value for determining whether the interference channel is present. When the co-scheduled neighboring electronic device 130 is present, and thus, the DMRS of the interference channel is present, the channel power value of P₁ according to Equation 12 may be greater than or equal to a certain level. Accordingly, in operation S540, when the channel power value of the second despread channel is greater than the threshold value, the electronic device 120 may identify that the co-scheduled neighboring electronic device 130 is present. In contrast, in operation S550, when the channel power value of the second despread channel is less than the threshold value, the electronic device 120 may identify that the co-scheduled neighboring electronic device 130 is not present.

In the above-described embodiment, the electronic device 120 compares the threshold value with the channel power value, but the disclosure is not limited thereto. According to one or more embodiments, the electronic device 120 may determine the presence or absence of the co-scheduled neighboring electronic device 130, based on whether the channel power of the second despread channel is greater than a certain ratio, compared to the channel power of the first despread channel. The electronic device 120 may determine whether P₁>Y|\tilde{h}₀ |²| is satisfied. γ may be a value representing a threshold ratio. For example, γ may be 0.2. When the channel power value P₁ of the second despread channel is greater than 20% of the channel power value P₀ of the first despread channel, the electronic device 120 may determine that the co-scheduled neighboring electronic device 130 is present.

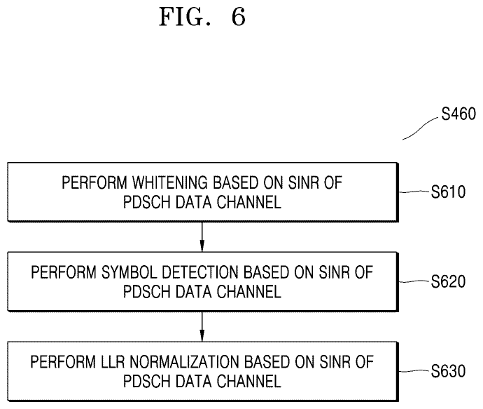

FIG. 6 illustrates details of operation S420 of the electronic device 120, according to an embodiment.

In FIG. 6, in operation S610, the electronic device 120 may perform whitening. At this time, since the whitening is for data processing of the PDSCH data channel, the electronic device 120 may perform whitening based on the SINR of the PDSCH data channel rather than by using the SNR of the DMRS.

In operation S620, the electronic device 120 may perform symbol detection. The electronic device 120 may detect a symbol based on Maximum Likelihood (ML). At this time, since the PDSCH data channel is used for calculating the Euclidean distance of the ML scheme, the electronic device 120 may perform symbol detection by using the SINR of the PDSCH data channel rather than by using the SNR of the DMRS channel.

In operation S630, the electronic device 120 may perform LLR normalization. For example, the electronic device 120 may perform normalization of LLRs corresponding to the symbol detection result of operation S620. Since the LLR is calculated based on the PDSCH data channel, the electronic device 120 may perform LLR normalization based on the SINR of the PDSCH data channel rather than by using the SNR of the DMRS channel.

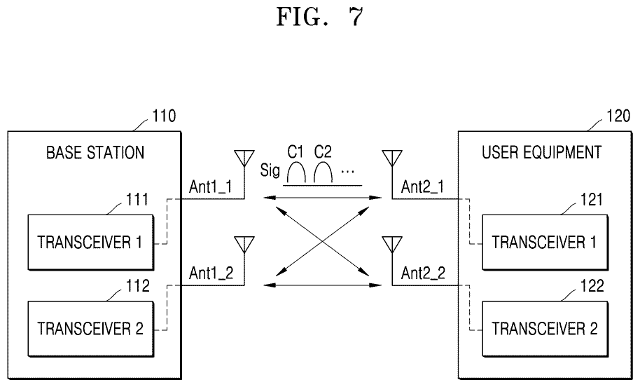

FIG. 7 illustrates a multiple input multiple output (MIMO) environment according to an embodiment.

In FIG. 7, a base station 110 and an electronic device 120 may communicate with each other by using a MIMO scheme. To this end, each of the base station 110 and the electronic device 120 may include a plurality of antennas Ant1_1, Ant1_2, Ant2_1, and Ant2_2. Although FIG. 7 illustrates that the base station 110 includes two antennas Ant1_1 and Ant1_2 and the electronic device 120 includes two antennas Ant2_1 and Ant2_2, but the disclosure is not limited thereto. It is obvious that the disclosure is also applicable to an embodiment in which each of the base station 110 and the electronic device 120 includes more than two antennas.

The base station 110 may include a first transceiver 111, a second transceiver 112, a first antenna Ant1_1, and a second antenna Ant1_2. Each of the first transceiver 111 and the second transceiver 112 may be connected to one antenna. For example, the first transceiver 111 may be connected to the first antenna Ant1_1 and the second transceiver 112 may be connected to the second antenna Ant1_2. When the base station 110 operates as a transmitting device, the first transceiver 111 and the second transceiver 112 may operate as transmitters, and when the base station 110 operates as a receiving device, the first transceiver 111 and the second transceiver 112 may operate as receivers.

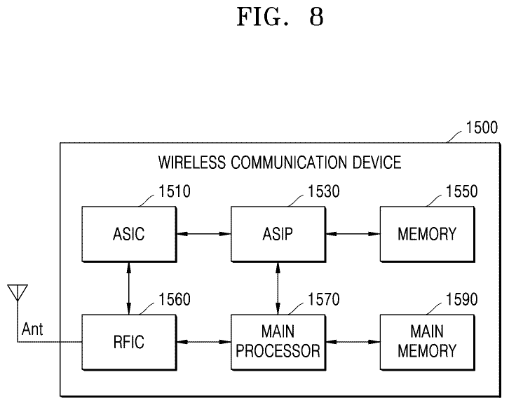

FIG. 8 illustrates a wireless communication device 1500 according to an embodiment.

In FIG. 8, the wireless communication device 1500 may include a modem and a radio frequency integrated circuit (RFIC) 1560. The modem may include an application specific integrated circuit (ASIC) 1510, an application specific instruction set processor (ASIP) 1530, a memory 1550, a main processor 1570, and a main memory 1590. The wireless communication device 1500 of FIG. 8 may be the electronic device 120 according to the embodiment.

The RFIC 1560 may be connected to an antenna Ant and may receive signals from the outside or transmit signals to the outside by using a wireless communication network. The ASIP 1530 is an integrated circuit customized for a specific purpose and may support a dedicated instruction set for a specific application and execute instructions included in the instruction set. The memory 1550 may communicate with the ASIP 1530 and may be a non-transitory storage device that stores a plurality of instructions to be executed by the ASIP 1530. The memory 1550 may include any type of memory that is accessible by the ASIP 1530. Non-limiting examples of the memory 1550 may include random access memory (RAM), read-only memory (ROM), tape, magnetic disk, optical disk, volatile memory, nonvolatile memory, and any combination thereof.

The main processor 1570 may control the wireless communication device 1500 by executing the plurality of instructions. For example, the main processor 1570 may control the ASIC 1510 and the ASIP 1530, may process data received over the wireless communication network, or may process user input to the wireless communication device 1500. The main memory 1590 may communicate with the main processor 1570 and may be a non-transitory storage device that stores a plurality of instructions to be executed by the main processor 1570. The main memory 1590 may include any type of memory that is accessible by the main processor 1570. Non-limiting examples of the main memory 1590 may include RAM, ROM, tape, magnetic disk, optical disk, volatile memory, nonvolatile memory, and any combination thereof.

In the embodiments of FIGS. 1 to 8 described above, it is assumed that the port 1000 is allocated to the electronic device 120, but the disclosure is not limited thereto. Likewise, in the embodiments of FIGS. 1 to 8, the environment of the serving channel and the interference channel assumes an additive white Gaussian noise (AWGN) channel, but may be generalized to other channels, and the disclosure is not limited thereto.

While the disclosure has been particularly shown and described with reference to embodiments thereof, various changes in form and details may be made therein without departing from the spirit and scope of the following claims.

What is claimed is:

1. An operating method of an electronic device, the operating method comprising:
receiving a signal comprising a Demodulation Reference Signal (DMRS) and Physical Downlink Shared Channel (PDSCH) data;
determining whether a co-scheduled neighboring electronic device is present, based on despread of the DMRS;
performing channel estimation on each of a serving channel for the electronic device and an interference channel for a neighboring electronic device, based on the despread of the DMRS;
calculating a variance of noise not including an interference signal, based on the co-scheduled neighboring electronic device;
calculating a Signal-to-Noise-Ratio (SNR) for the DMRS and a Signal-to-Interference-Noise-Ratio (SINR) for the PDSCH data; and
decoding the PDSCH data based on the SINR.

2. The operating method of claim 1, wherein the determining whether the co-scheduled neighboring electronic device is present, based on the despread of the DMRS, comprises:
obtain a first despread channel corresponding to the serving channel and a second despread channel corresponding to the interference channel by performing Orthogonal Cover Code (OCC) despreading on the DMRS;
calculating a channel power value of the second despread channel;
when the channel power value is greater than or equal to a predefined threshold value, determining that the co-scheduled neighboring electronic device is present; and
when the channel power value is less than the predefined threshold value, determining that the co-scheduled neighboring electronic device is not present.

3. The operating method of claim 1, wherein the determining whether the co-scheduled neighboring electronic device is present, based on the despread of the DMRS, comprises:
obtain a first despread channel corresponding to the serving channel and a second despread channel corresponding to the interference channel by performing Orthogonal Cover Code (OCC) despreading on the DMRS;
calculating a first channel power value of the first despread channel and a second channel power value of the second despread channel;
when the second channel power value is greater than or equal to a value obtained by multiplying the first channel power value by a predefined threshold value, determining that the co-scheduled neighboring electronic device is present; and
when the second channel power value is less than the value obtained by multiplying the first channel power value by the predefined threshold value, determining that the co-scheduled neighboring electronic device is not present.

4. The operating method of claim 2, wherein the performing the channel estimation on each of the serving channel for the electronic device and the interference channel for the co-scheduled neighboring electronic device, based on the despread of the DMRS, comprises:
generating a first weight matrix for the first despread channel; and
generating a second weight matrix for the second despread channel, and
wherein the first weight matrix and the second weight matrix are generated based on an SNR calculated in a previous slot.

5. The operating method of claim 4, wherein the performing the channel estimation on each of the serving channel for the electronic device and the interference channel for the co-scheduled neighboring electronic device, based on the despread of the DMRS, further comprises:
performing the channel estimation on the serving channel by multiplying the first weight matrix by the first despread channel; and
performing the channel estimation on the interference channel by multiplying the second weight matrix by the second despread channel.

6. The operating method of claim 5, wherein the channel estimation is based on a Linear Minimum Mean Square Error (LMMSE).

7. The operating method of claim 1, wherein a DMRS sequence of the electronic device is identical to a DMRS sequence of the co-scheduled neighboring electronic device.

8. An electronic device comprising:
a wireless communication circuit configured to receive a signal comprising a Demodulation Reference Signal (DMRS) and Physical Downlink Shared Channel (PDSCH) data; and
a processor operatively connected to the wireless communication circuit,
wherein the processor is configured to:
determine whether a co-scheduled neighboring electronic device is present, based on despread of the DMRS,
perform channel estimation on each of a serving channel for the electronic device and an interference channel for the co-scheduled neighboring electronic device, based on the despread of the DMRS,
calculate a variance of noise not including an interference signal, based on the co-scheduled neighboring electronic device,
calculate a Signal-to-Noise-Ratio (SNR) for the DMRS and a Signal-to-Interference-Noise-Ratio (SINR) for the PDSCH data, and
decode the PDSCH data based on the SINR.

9. The electronic device of claim 8, wherein the processor is further configured to:
obtain a first despread channel corresponding to the serving channel and a second despread channel corresponding to the interference channel by performing Orthogonal Cover Code (OCC) despreading on the DMRS;
calculate a channel power value of the second despread channel;
when the channel power value is greater than or equal to a predefined threshold value, determine that the co-scheduled neighboring electronic device is present; and
when the channel power value is less than the predefined threshold value, determine that the co-scheduled neighboring electronic device is not present.

10. The electronic device of claim 8, wherein the processor is further configured to:
obtain a first despread channel corresponding to the serving channel and a second despread channel corresponding to the interference channel by performing Orthogonal Cover Code (OCC) despreading on the DMRS;
calculate a first channel power value of the first despread channel and a second channel power value of the second despread channel;
when the second channel power value is greater than or equal to a value obtained by multiplying the first channel power value by a predefined threshold value, determine that the co-scheduled neighboring electronic device is present; and
when the second channel power value is less than the value obtained by multiplying the first channel power value by the predefined threshold value, determine that the co-scheduled neighboring electronic device is not present.

11. The electronic device of claim 9, wherein the processor is further configured to perform channel estimation on each of the serving channel for the electronic device and the interference channel for the co-scheduled neighboring electronic device by generating a first weight matrix for the first despread channel and generating a second weight matrix for the second despread channel, and
wherein the first weight matrix and the second weight matrix are generated based on an SNR calculated in a previous slot.

12. The electronic device of claim 11, wherein the processor is further configured to:
perform the channel estimation on the serving channel by multiplying the first weight matrix by the first despread channel; and
perform the channel estimation on the interference channel by multiplying the second weight matrix by the second despread channel.

13. The electronic device of claim 12, wherein the channel estimation is based on a Linear Minimum Mean Square Error (LMMSE).

14. The electronic device of claim 8, wherein a DMRS sequence of the electronic device is identical to a DMRS sequence of the co-scheduled neighboring electronic device.

15. A wireless communication system comprising:
a base station configured to transmit a signal comprising a Demodulation Reference Signal (DMRS) and Physical Downlink Shared Channel (PDSCH) data multiplexed based on an Orthogonal Cover Code (OCC); and
an electronic device configured to:
determine whether a co-scheduled neighboring electronic device is present, based on despread of the DMRS,
perform channel estimation on each of a serving channel for the electronic device and an interference channel for the co-scheduled neighboring electronic device, based on the despread of the DMRS, calculate a variance of noise not including an interference signal, based on the co-scheduled neighboring electronic device,
calculate a Signal-to-Noise-Ratio (SNR) for the DMRS and a Signal-to-Interference-Noise-Ratio (SINR) for the PDSCH data, and
decode the PDSCH data based on the SINR.

16. The wireless communication system of claim 15, wherein the electronic device is further configured to:
obtain a first despread channel corresponding to the serving channel and a second despread channel corresponding to the interference channel by performing OCC despreading on the DMRS;
calculate a channel power value of the second despread channel;
when the channel power value is greater than or equal to a predefined threshold value, determine that the co-scheduled neighboring electronic device is present; and
when the channel power value is less than the predefined threshold value, determine that the co-scheduled neighboring electronic device is not present.

17. The wireless communication system of claim 15, wherein the electronic device is further configured to:
obtain a first despread channel corresponding to the serving channel and a second despread channel corresponding to the interference channel by performing OCC despreading on the DMRS;
calculate a first channel power value of the first despread channel and a second channel power value of the second despread channel;
when the second channel power value is greater than or equal to a value obtained by multiplying the first channel power value by a predefined threshold value, determine that the co-scheduled neighboring electronic device is present; and
when the second channel power value is less than the value obtained by multiplying the first channel power value by the predefined threshold value, determine that the co-scheduled neighboring electronic device is not present.

18. The wireless communication system of claim 16, wherein the electronic device is further configured to generate a first weight matrix for the first despread channel and generate a second weight matrix for the second despread channel, and
wherein the first weight matrix and the second weight matrix are generated based on an SNR calculated in a previous slot.

19. The wireless communication system of claim 18, wherein the electronic device is further configured to:
perform the channel estimation on the serving channel by multiplying the first weight matrix by the first despread channel; and
perform the channel estimation on the interference channel by multiplying the second weight matrix by the second despread channel.

20. The wireless communication system of claim 19, wherein the channel estimation is based on a Linear Minimum Mean Square Error (LMMSE).
